(19) United States
(12) Patent Application Publication
(10) Pub. No.: US 2015/0266772 A1
(43) Pub. Date: Sep. 24, 2015

(54) SEALING MATERIAL, SUBSTRATE WITH SEALING MATERIAL LAYER, STACK, AND ELECTRONIC DEVICE

(71) Applicant: ASAHI GLASS COMPANY, LIMITED, Tokyo (JP)

(72) Inventors: Yoko MITSUI, Tokyo (JP); Satoshi TAKEDA, Tokyo (JP); Yohei NAGAO, Tokyo (JP)

(73) Assignee: ASAHI GLASS COMPANY, LIMITED, Tokyo (JP)

(21) Appl. No.: 14/729,302

(22) Filed: Jun. 3, 2015

Related U.S. Application Data
(63) Continuation of application No. PCT/JP2013/082794, filed on Dec. 6, 2013.

(30) Foreign Application Priority Data
Dec. 10, 2012 (JP) 2012-269530
Oct. 29, 2013 (JP) 2013-224013

(51) Int. Cl. C03C 8/24; B32B 15/04; B32B 17/06; B32B 7/14

(52) U.S. Cl. CPC C03C 8/24; B32B 7/14; B32B 15/04; B32B 17/06; B32B 2457/00; B32B 2457/14; C03C 2204/00

(57) ABSTRACT

A sealing material containing 30 to 99 mass % of a glass powder and 1 to 70 mass % of a conductive metal oxide powder.

### CROSS-REFERENCE TO RELATED APPLICATIONS

This application is a continuation of prior International Application No. PCT/JP2013/082794 filed on Dec. 6, 2013 which is based upon and claims the benefit of priority from Japanese Patent Application Nos. 2012-269530 filed on Dec. 10, 2012; and 2013-224013 filed on Oct. 29, 2013; the entire contents of all of which are incorporated herein by reference.

### FIELD

The present invention relates to a sealing material used in sealing of inorganic material substrates each other used for a flat display device and a lighting device, to a substrate with a sealing material layer, to a stack, and to an electronic device.

### BACKGROUND

As a sealing material for sealing inorganic material substrates such as glass substrates to each other, there is used a material (hereinafter, also referred to as a glass frit) containing glass powder as a main constituent and an organic resin such as an epoxy resin. In sealing which uses the above sealing materials, retention of airtightness and water tightness (hereinafter, these are combinedly referred to as adhesiveness) of the sealed inside has been conventionally required. Further, because of increased designability of a product, coloring variation and transparency in a sealed portion are increasingly requested in recent years.

Sealing by the organic resin, being capable of making the sealed portion colored or transparent, is excellent in design (for example, Patent Reference 1 (JP-A 2008-214512)). However, there are problems that adhesiveness of the sealed portion is insufficient and that discoloring occurs in the sealed portion with time.

In contrast, in sealing with the glass frit, adhesiveness of a sealed portion is able to be increased, and further, discoloring with time is hard to occur because of stability of glass. In sealing with the glass frit, there is a method of sealing by heating an electronic device having a substrate, a device, and a sealing material simultaneously in a heating furnace or the like. As another method, there is a method of sealing by heating only a sealing material by laser irradiation, and sealing by laser irradiation (hereinafter, referred to as laser sealing), enabling sealing without heating of a device, is often used in recent years.

In laser sealing, it is indispensable for a glass frit to contain coloring pigment such as a carbon material which absorbs laser light and converts into heat. For example, Patent Reference 2 (JP-A 2011-057477) describes, as a sealing material used in laser sealing, a glass frit which contains 70 to 99.9 vol % of a glass powder and a ceramics powder in total amount and contains 0.1 to 20 vol % of a powder of transition metal oxide which absorbs laser light. Further, as the transition metal oxide powder, use of powder of Co₃O₄, CuO, Cr₂O₃, and so on is described.

However, when the glass frit is made to contain such a carbon material on transition metal oxide powder, the sealed portion is colored, making it difficult to respond to request on design. In other words, adhesiveness and securement of design both depend on a sealing material to be used, but a conventional sealing material has not satisfied both characteristics.

Further, in view of workability of laser sealing, a material is required which allows a broad output range of laser light which enables sealing, that is, which has a large margin (flexibility) of laser output.

### DISCLOSURE OF THE INVENTION

The present invention is made in view of the above circumstances, and an object thereof is to provide a sealing material for laser sealing which can increase adhesiveness of a sealed portion and can make the sealed portion transparent or white.

The present invention is to solve the above-described problems by making a sealing material contain conductive metal oxide powder. In other words, the sealing material of the present invention is a sealing material containing a glass powder and a conducive metal oxide powder, wherein the glass powder is contained at a percentage of 30 to 99 mass % and the conductive metal oxide powder is contained at a percentage of 1 to 70 mass %.

Further, a substrate with a sealing material layer of the present invention has a sealing material layer made by firing the sealing material in a predetermined region on a surface of an inorganic material substrate.

Further, a stack of the present invention has: a first substrate having a first sealing region on a sealing side surface; a second substrate having a second sealing region corresponding to the first sealing region on a surface facing the first substrate, the second substrate disposed over a predetermined space from the first substrate; and a sealing layer formed between the first sealing region and the second sealing region and made by melting and solidifying the sealing material of the present invention.

Further, an electronic device of the present invention has: an electronic element provided between the first substrate and the second substrate; and a sealing layer formed between the first sealing region and the second sealing region in a manner to seal the electronic element and made by melting and solidifying the sealing material of the present invention.

By using a sealing material of the present invention for laser sealing, it is possible to obtain a sealed portion which is white or transparent and good in design and which has high airtightness and water tightness.

### BRIEF DESCRIPTION OF THE DRAWINGS

FIG. 1 is a plan view showing an inorganic material substrate (first substrate) which has a sealing material layer.

FIG. 2 is a plan view showing an inorganic material substrate (second substrate) which does not have a sealing material layer.

FIG. 3A is a cross-sectional view showing a process of making the first substrate 1 and the second substrate 2 face each other, in a process of laser sealing of the embodiment.

FIG. 3B is a cross-sectional view showing a process of disposing and overlapping the first substrate 1 and the second substrate 2 having been made to face each other, in the process of laser sealing of the embodiment.

FIG. 3C is a cross-sectional view showing a process of forming a sealing layer 10 between the first substrate 1 and the second substrate 2 in the process of laser sealing of the embodiment.

FIG. 3D is a cross-sectional view showing a process of obtaining a stack 9 in which the first substrate 1 and the second substrate 2 are sealed via the sealing layer 10, in the process of laser sealing of the embodiment.

### DETAILED DESCRIPTION

(Constitution of Sealing Material)

A sealing material being a first embodiment of the present invention is a material which contains a glass powder and a conductive metal oxide powder, containing 30 to 99 mass % of the glass powder and 1 to 70 mass % of the conductive metal oxide powder. The sealing material of the first embodiment is applicable to various sealing methods, and is the most preferable material for sealing using laser light, that is, laser sealing.

In a case where the sealing material is constituted with only the glass powder, irradiated laser light cannot be converted into heat efficiently, so that the glass powder cannot be melted in a short time. Thus, the conductive metal oxide powder to convert laser light into heat, preferably a transparent conductive metal oxide powder (hereinafter, referred to as a “transparent conductive oxide powder”), is necessary. Further, as a result that the sealing material contains ceramics powder with a coefficient of thermal expansion (hereinafter, referred to as CTE) smaller compared with that of the glass, CTE of the sealing material can be made small, leading to prevention of a crack or the like occurring in a glass frit or an inorganic material substrate due to a residual stress. However, excessive inclusion of the ceramics powder makes it difficult to materialize both reduction of thermal expansion and improvement of fluidity at a time of melting of the sealing material.

The present inventors conducted extensive studies and found that by adjusting contents of the above properly, light energy by laser irradiation can be converted into thermal energy efficiently, to be able to melt glass, and to be able to prevent occurrence of a crack in a sealed portion also.

A sealing material of a first embodiment is preferable, in a case of further containing ceramics powder, to be composed of 30 to 99 mass % of the glass powder and the ceramics powder in total amount and 1 to 70 mass % of the conductive metal oxide powder in relation to an entire sealing material, in practice.

Further, the present inventors found that by using powder of tin-based oxide containing a dopant as the conductive metal oxide powder and adjusting a content of the powder of tin-based oxide containing the dopant properly, light energy by laser irradiation can be converted into thermal energy efficiently, to be able to melt the glass powder. Moreover, the powder of tin-based oxide containing the dopant is not only good in laser absorbency but also able to give low expansivity to a sealing material, so that CTE can be made small. Consequently, it becomes possible to adopt a broad output range of laser light where sealing with high airtightness is possible, without occurrence of pealing of the sealed portion, a crack of the inorganic material substrate, or the like.

In a case where the sealing material of the first embodiment contains a tin-based oxide containing a dopant as the conductive metal oxide, the sealing material of the present embodiment is preferable to be composed of, in practice, 70 to 95 vol % of the glass powder and the ceramics powder in total amount and 5 to 30 vol % of the powder of tin-based oxide containing the dopant in relation to an entire sealing material. Note that “composed of, in practice” means that inevitable impurities are allowed to be mixed though not being positively contained.

(Mechanism of Laser Sealing)

An example of a mechanism assumed in laser sealing using the sealing material of the present invention will be described.

In laser sealing, irradiated laser light is absorbed by a predetermined material and light energy is converted into thermal energy, and after the glass powder is melted by that thermal energy, the melted glass is cooled and solidified, so that a sealed portion is formed. In other words, the sealing material is required to contain a laser absorbent which absorbs laser light.

Here, light absorption caused by a transition metal oxide such as black pigment includes absorption equivalent to band-to-band transition, absorption equivalent to band-to-band transition by a dopant carrier, and absorption by a free electron of a conduction band. In a conventional sealing material which contains the transition metal oxide powder, light energy is converted into thermal energy by using light absorption equivalent to band-to-band transition of the transition metal oxide or band-to-band transition by the dopant carrier. Laser light used in laser sealing is usually light in a near-infrared wavelength region of near 808 nm in wavelength, and for the purpose of efficient absorption of light of this wavelength region, blackish pigment or a transition metal oxide which has a high absorbing capacity for a visible wavelength region and a near-infrared wavelength region has been contained as a laser absorbent in a sealing material.

In contrast, the conductive metal oxide, the transparent conductive oxide powder in particular, contained in the sealing material in the present invention has a broad band width, and thus cannot absorb light of the visible wavelength region and the near-infrared wavelength region by band-to-band transition, but since having a free electron in a conduction band, light absorption equivalent to free electron absorption occurs when light of the near-infrared wavelength region is irradiated. Thus, light of an infrared wavelength region of 1000 nm or more in wavelength is absorbed. Therefore, in the sealing material containing the transparent conductive oxide, it is possible to melt the glass powder by using conversion from light energy absorbed by the free electron in the conduction band into thermal energy as above. Absorption by the free electron is low in absorption efficiency compared with absorption of band-to-band transition, but when a concentration of free electrons (or carrier concentration) of the conduction band becomes sufficiently high, light energy to be absorbed becomes large, so that sufficient thermal energy to melt the glass powder can be obtained.

Hereinafter, each component contained in the sealing material of the first embodiment of the present invention will be described.

(Conductive Metal Oxide Powder)

In the sealing material of the present invention, a content of the conductive metal oxide powder, preferably the transparent conductive oxide powder, is 1 to 70 mass % of the entire sealing material. When the content of the conductive metal oxide powder is less than 1 mass %, a free electron concentration in the sealing material is too low to absorb light sufficiently. Therefore, laser light cannot be converted into heat efficiently and glass cannot be melted sufficiently, there being a possibility that adhesiveness of the sealed portion is reduced. The content of the conductive metal oxide powder is preferably 3 mass % or more and further preferably 5 mass % or more. On the other hand, the content over 70 mass % reduces fluidity of the glass powder, reduces adhesive strength of the sealed portion, and reduces reliability of the sealed portion. Besides, the content of the conductive metal oxide powder is preferably 50 mass % or less and further preferably 30 mass % or less. The content of the conductive metal oxide powder, when indicated in vol %, is 1 to 60 vol % of the entire sealing material. The content is preferably 3 vol % or more and further preferably 5 vol % or more, and preferably 43 vol % or less and further preferably 26 vol % or less. The conductive metal oxide powder is preferably the transparent conductive oxide powder and more preferably powder of tin-based oxide containing a dopant.

In the present specification, it suffices if the conductive metal oxide is a metal oxide having conductivity, and there can be cited a monolithic metal oxide, a composite metal oxide, and a metal oxide containing a dopant. The transparent conductive oxide in particular is broadly known as TCO. The above materials are mainly film-formed and used as electrode materials of various displays as transparent metals, and the material whose specific resistance of a film becomes 1×10⁻⁴ to 9×10⁻³ Ω·cm when film-formed is preferable. Powder of a conductive oxide material having such a specific resistance can convert laser light into heat efficiently and is preferable. Further, as the conductive metal oxide, only one kind of the above-described monolithic metal oxide, composite metal oxide, and metal oxide containing the dopant may be used, or two or more kinds may be used in combination. For example, a later-described ITO (tin-doped indium oxide) may be used solo or ITO and FTO (fluorine-doped tin oxide) may be used in combination.

As the transparent conductive oxide being the conductive metal oxide, an indium-based oxide, a tin-based oxide, and a zinc-based oxide are preferable. Here, the aforementioned “-based” means a conductive metal oxide containing a specified component as a main component, meaning that the above-described component is contained at a proportion of equal to or more than 50 mass %. As the transparent conductive oxide of the indium-based oxide, ITO can be cited. A tin-based oxide containing a dopant can be used as the transparent conductive oxide of the tin-based oxide. For a dopant material contained in the tin-based oxide, Sb, Nb, Ta, F or the like can be used preferably, and conductivity can be heightened by making the tin-based oxide contain the above. As the tin-based oxide containing the dopant, FTO and ATO (antimony-doped tin oxide) can be used, for example. As the transparent conductive oxide of the zinc-based oxide, ZnO containing a dopant can be cited, and as a dopant material contained in the zinc-based oxide is preferable to be one or more selected from the group consisting of B, Al, Ga, In, Si, Ge, Ti, Zr, and Hf.

A maximum particle diameter Dₘₐₓ of the conductive metal oxide powder is at least less than an average thickness of the sealed portion, and the thickness of the sealed portion depends on a purpose for which the sealing material is used. For example, when a thickness of a sealed portion is 50 μm to 100 μm as in sealing of double layer glass, Dₘₐₓ of the conductive metal oxide powder is preferable to be 40 μm to 90 μm. Thereby, a crack or the like at a time of laser sealing can be prevented and fluidity of glass powder can be secured. On the other, when a thickness of a sealed portion is 7 μm or less as in sealing of an electronic device, Dₘₐₓ of conductive metal oxide powder is preferable to be 5 μm or less. Thereby, the sealed portion can be made thin, and thus miniaturization and thickness reduction of the electronic device can be coped with.

Further, as the conductive metal oxide, the tin-based oxide containing the dopant is preferable among those described above. It is because conductivity can be heightened by making the tin-based oxide contain the dopant. In particular, ATO being a tin oxide in which antimony is doped has good conductivity, and thus is preferable. In consideration of a load to the environment, it is preferable to use Nb, Ta, or F as the dopant.

When the tin-based oxide containing the dopant is used as the conductive metal oxide, a content of the tin-based oxide containing the dopant is preferable to be 5 to 30 vol % of the entire sealing material. If the content of the tin-based oxide containing the dopant is less than 5 vol %, a free electron concentration in the sealing material is low and sufficient light absorption cannot be carried out. Thus, laser light cannot be converted into heat efficiently and glass cannot be sufficiently melted, whereby there is a possibility that adhesiveness of a sealed portion is reduced. The content of the tin-based oxide containing the dopant is preferably 7 vol % or more of the entire sealing material, and more preferably 10 vol % or more. On the other hand, if the content of the tin-based oxide containing the dopant exceeds 30 vol %, there is a possibility that a crack occurs due to local heat generation near an interface at a time of laser irradiation or that adhesiveness is reduced due to reduced fluidity at a time of melting of the sealing material. The content of the tin-based oxide containing the dopant is preferably 25 vol % or less of the entire sealing material, and more preferably 20 vol % or less.

D₅₀ of the powder of tin-based oxide containing the dopant is preferable to be in a range of 0.1 μm to 5 μm, and is more preferable to be 1 μm to 3 μm. If D₅₀ of the powder of tin-based oxide containing the dopant is less than 0.1 μm, an effect of addition of the powder of tin-based oxide containing the dopant is small since the powder of tin-based oxide containing the dopant liquates into the melted glass. If D₅₀ of the powder of tin-based oxide containing the dopant exceeds 5 μm, uniform dispersion in the sealing material becomes insufficient, so that uniform heating becomes difficult. Note that in the present specification D₅₀ is a value measured by means of a laser diffraction-diffusion method by using a particle size analyzer.

(Glass Powder)

In the sealing material of the first embodiment of the present invention, a various kinds of glass can be used as glass constituting the glass powder. In particular, low-melting point glass is preferable, since glass can be melted and sealing is possible even if energy of irradiated laser light is small. As such a low-melting point glass, there can be cited bismuth-based glass, tin phosphate-based glass, vanadium-based glass, zinc borate-based glass, and so on. Since such glass has a low melting point and can secure sufficient fluidity, it is possible to heighten adhesive strength between the sealing material and a later-described inorganic material substrate (for example, glass substrate). Here, the aforementioned “-based glass” means glass containing a specified component as a main component, meaning that in a case where the main component is a single component the single component is contained at a proportion of 50 mass % or more, and that in a case where the main component is composed of a plurality of components the plurality of components are contained at a proportion of 50 mass % or more in total content.

As the glass composition of the glass powder, bismuth-based glass and tin phosphate-based glass are preferable, and bismuth-based glass is more preferable, considering adhesiveness to a glass substrate and reliability thereof, and further, influence to the environment and human bodies.

The bismuth-based glass is preferable to contain 70 to 90% of Bi₂O₃, 1 to 20% of ZnO, and 2 to 12% of B₂O₃ in mass percentage based on oxides.

Bi₂O₃ is a component forming a network of glass and is an essential component in the bismuth-based glass. A content of Bi₂O₃ is preferable to be 70 to 90%, since a softening temperature of glass can be lowered thereby. The content of Bi₂O₃ is more preferable to be 75% or more and is further preferable to be 80% or more. Further, the content of Bi₂O₃ is more preferable to be 87% or less and is further preferable to be 85% or less.

A content of ZnO is preferable to be 1 to 20%, since CTE and the softening temperature of glass can be lowered thereby. In order to improve stability of glass, the content of ZnO is more preferable to be 5% or more, and is further preferable to be 10% or more. Further, the content of ZnO is more preferable to be 17% or less, and is further preferable to be 15% or less.

A content of B₂O₃ is preferable to be 2 to 12%, since a range enabling vitrification can be broadened thereby. The content of B₂O₃ is more preferable to be 4% or more. Further, the content of B₂O₃ is more preferable to be 10% or less, and is further preferable to be 7% or less.

The bismuth-based glass composed of the aforementioned three components has a low glass transition point and suitable for a sealing material. For the purpose of stabilization of glass, it is preferable to contain a component of one or more selected from the group consisting of Al₂O₃, SiO₂, CaO, SrO, and BaO, other than the above-described three components. A content of them is preferable to be 5% or less in total.

Further, other than the aforementioned components, it is possible to contain a component of one or more selected from the group consisting of Cs₂O, CeO₂, Ag₂O, WO₃, MoO₃, Nb₂O₃, Ta₂O₅, Ga₂O₃, Sb₂O₃, P₂O₅, and SnOₓ. Cs₂O has an effect to reduce a softening temperature of glass and CeO₂ has an effect to stabilize fluidity of glass. Further, Ag₂O, WO₃, MoO₃, Nb₂O₃, Ta₂O₅, Ga₂O₃, Sb₂O₃, P₂O₅, and SnOₓ or the like can adjust a viscosity, CTE, or the like of glass. A content of each of the above component is preferable to be 10% or less in total.

A maximum particle diameter Dₘₐₓ of glass powder is preferable to be smaller than a thickness of a sealed portion, that is, a gap between both inorganic material substrates. Note that the thickness of the sealed portion depends on a purpose for which the sealing material is used. When a thickness of a sealed portion is 50 μm to 100 μm, Dₘₐₓ of glass powder is preferable to be 40 μm to 90 μm. Thereby, fluidity of the glass powder can be secured. On the other hand, when a thickness of a sealed portion is 7 μm or less as in sealing of an electronic device, Dₘₐₓ of glass powder is preferable to be 5 μm or less. Thereby, the sealed portion can be made thin, and thus miniaturization and thickness reduction of the electronic device can be coped with. Note that in the present specification Dₘₐₓ is a value measured by means of a laser diffraction-diffusion method by using a particle size analyzer.

(Ceramics Powder)

In the sealing material of the first embodiment of the present invention, the ceramics powder is not limited in particular as long as the ceramics powder is an inorganic crystalline material whose CTE (in particular, linear expansion coefficient, the same applies hereinafter) is lower than that of the glass powder constituting the sealing material. By containing the ceramics powder, a stress generated at a time of laser sealing can be suppressed, and a crack of an inorganic material substrate or the like due to such stress can be prevented.

As the ceramics powder, it is preferable to use at least one or more selected from the group consisting of magnesia, calcia, silica, alumina, zirconia, zircon, cordierite, zirconium phosphate tungstate, zirconium tungstate, zirconium phosphate, zirconium silicate, aluminum titanate, mullite, eucryptite, and spodumene. The above ceramics powder has good compatibility with glass and sealing strength of the sealing material can be made larger compared with a case where the glass powder is used solo.

Further, other than the above-described ceramics powder, quartz glass or the like can be contained for the purpose of adjustment of a linear expansion coefficient as well as improvement of fluidity of glass and sealing strength of the sealed portion.

Dₘₐₓ of the ceramics powder is also preferable to be smaller than a thickness of a sealed portion, similarly to in a case of the glass powder. Note that the thickness of the sealed portion depends on a purpose for which the sealing material is used. When a thickness of a sealed portion is 50 μm to 100 μm, Dₘₐₓ of the ceramics powder is preferable to be 40 μm to 90 μm. Thereby, a crack or the like at a time of sealing due to generation of a projection on a sealed portion surface can be prevented. On the other hand, when a thickness of a sealed portion is 7 μm or less as in a case of sealing of an electronic device, Dₘₐₓ of the ceramics powder is preferable to be 5 μm or less. Thereby, the sealed portion can be made thin, and thus miniaturization and thickness reduction of the electronic device can be coped with.

(Glass-Ceramics Powder)

In the sealing material of the present invention, the content of the glass powder is 30 to 99 mass % in the sealing material. If the content of the glass powder is less than 30 mass %, adhesive strength of the sealed portion is not sufficient, leading to reduction of its reliability. The content of the glass powder is preferably 50 mass % or more in the sealing material, and further preferably 70 mass % or more. On the other hand, if the content of the glass powder is over 99 mass %, the content of the conductive metal oxide powder is small, and thus irradiated laser light cannot be converted into heat efficiently and cannot melt glass sufficiently, so that there is a possibility that adhesiveness of the sealed portion is reduced. The content of the glass powder is preferably 97 mass % or less, and further preferably 95 mass % or less. Further, the content of the glass powder is preferable to be 50 to 97 mass % and is more preferable to be 70 to 95 mass %. The content of the glass powder is 40 to 99 vol % when indicated in vol %. The content of the glass powder is preferably 50 vol % or more, and further preferably 70 vol % or more. The content of the glass powder is preferably 97 vol % or less, and further preferably 95 vol % or less.

In the sealing material of the present invention, when the ceramics powder is further contained, it is preferable to contain more than 30 mass % and 99 mass % or less of the glass powder and the ceramics powder in total amount in the sealing material. Further, under a condition satisfying the content of the glass powder in the sealing material being 30 mass % or more, in order to secure fluidity of the glass powder and to heighten adhesive strength of the sealed portion, in a case where a total amount of the glass powder and the ceramics powder is 100 mass %, it is preferable to contain 30 to 99 mass % of the glass powder and 1 to 70 mass % of the ceramics powder. Further, it is more preferable to contain 50 to 90 mass % of the glass powder and 10 to 50 mass % of the ceramics powder, in the above total amount. When indicated in vol %, it is preferable to contain more than 40 vol % and 99 vol % or less of the glass powder and ceramics powder in total amount in the sealing material. Further, under a condition satisfying the content of the glass powder in the entire sealing material being 40 vol % or more, in a case where a total amount of the glass powder and the ceramics powder is 100%, it is preferable to contain 40 to 99 vol % of the glass powder and 1 to 60 vol % of the ceramics powder, and it is more preferable to contain 50 to 90 vol % of the glass powder and 10 to 50 vol % of the ceramics powder, in the above total amount.

Further, in a case where the powder of tin-based oxide containing the dopant is used as the conductive metal oxide powder, the content of the powder of tin-based oxide containing the dopant is 5 to 30 vol % and the total content of the glass powder and the ceramics powder is 70 to 95 vol % preferably. In this case, in order to secure fluidity of the glass powder and to heighten adhesive strength of the sealed portion, when a total amount of the glass powder and the ceramics powder is 100 vol %, it is preferable to contain 50 to 95 vol % of the glass powder and 5 to 50 vol % of the ceramics powder.

When the tin-based oxide containing the dopant is used as conductive metal oxide powder, a content of glass powder is preferable to be 35 to 90.25 vol % of the entire sealing material. If the content of the glass powder is less than 35 vol %, adhesive strength of the sealed portion is not sufficient, leading to reduction in reliability. On the other hand, if the content exceeds 90.25 vol %, the content of the tin-based oxide containing the dopant becomes comparatively smaller, and thus irradiated laser light cannot be converted into heat efficiently, so that glass cannot be melted sufficiently. Thus, there is a possibility that adhesiveness of the sealed portion is reduced. The content of the glass powder is more preferable to be 55 to 75 vol %.

A linear expansion coefficient of the sealing material of the present invention is preferable to be 90×10⁻⁷/° C. or less, is more preferable to be 88×10⁻⁷/° C. or less, and is further preferable to be 85×10⁻⁷/° C. or less. Thereby, it is possible to decrease a thermal expansion amount of the sealed portion at a time of laser irradiation and to suppress a crack occurring due to a residual stress.

Further, when the sealing material of the first embodiment contains the glass powder, the ceramics powder, and the powder of tin-based oxide containing the dopant, respectively, it becomes possible to make CTE of the sealing material further smaller. By decreasing a thermal expansion amount of the sealing material at the time of laser irradiation, a residual stress due to a rapid heating and/or rapid cooling process can be suppressed. In particular, in a case where the linear expansion coefficient of the glass substrate is 70×10⁻⁷/° C. or more, when a plate thickness of the inorganic material substrate is 2 mm or more, or when different substrates are sealed to each other, a crack due to a residual stress is easy to occur, and thus the linear expansion coefficient of the sealing material is preferable to be 80×10⁻⁷/° C. or less, is more preferable to be 70×10⁻⁷/° C. or less, and is further preferable to be 65×10⁻⁷/° C. or less. In order to make the linear expansion coefficient of the sealing material be 80×10⁻⁷/° C. or less, it is preferable to increase the content of the ceramics powder in the sealing material. In order to make the linear expansion coefficient of sealing material be in a preferable range of 65×10⁻⁷/° C. or less, it is necessary to contain the ceramics powder further more, but increase in content of the ceramics powder causes reduction of fluidity of the sealing material. In order to make the sealing material flow sufficiently at a time of heating to obtain sufficient adhesiveness to a substrate, it is necessary to increase a temperature of heating of a sealing material by laser light, but the increased temperature makes the residual stress large.

Here, since the tin-based oxide containing the dopant lowers not only laser absorbability but also CTE of the sealing material, it is not until addition of 5 to 30 vol % tin-based oxide containing the dopant that CTE of 65×10⁻⁷/° C. or less becomes possible.

A softening temperature of the sealing material of the first embodiment is preferable to be 600° C. or less, is more preferable to be 500° C. or less, and is further preferable to be 400° C. or less. When the softening temperature is 600° C. or less, sealing is possible even with low laser light output, which leads to a higher manufacturing efficiency and a smaller residual stress to occur, and is preferable. A lower limit of the softening temperature is not limited in particular. Note that in the present specification the softening temperature is a value obtained by measuring a third inflection point of a differential thermal analysis device (DTA).

(Sealing Material Paste)

The sealing material being the first embodiment of the present invention is preferable to be used as a sealing material paste (hereinafter, also referred to as a “glass paste”) by being mixed uniformly with a vehicle. Being the glass paste makes handling easier compared with use in a shape of powder. The vehicle constituting the glass paste together with the sealing material contains a resin binder and an organic solvent. Further, the glass paste may contain a surface active agent or a thickener as necessary.

A viscosity of the glass paste can be adjusted by a mixture ratio of the sealing material and the vehicle as well as a mixture ratio of the organic binder and the organic solvent in the vehicle. A well-known method using a mixer of a rotation type having stirring blades, a roll mill, a ball mill, or the like is applicable to preparation of the glass pastes.

Usable as the resin binder are methyl cellulose, carboxymethyl cellulose, oxyethyl cellulose, benzyl cellulose, propyl cellulose, acrylic resin obtained by polymerising methacrylate ester, methyl (meth)acrylate, ethyl (meth)acrylate, butyl (meth)acrylate, and 2-hydroxyethyl methacrylate and so on, ethyl cellulose, polyethylene glycol derivative, nitrocellulose, polymethylstyrene, polyethylene carbonate, and so on.

Usable as the organic solvent are N,N′-dimethylformamide (DMF), α-terpineol, higher alcohol, γ-butyrolactone (γ-BL), tetralin, ethyl carbitol acetate, butyl carbitol acetate, methyl ethyl ketone, ethyl acetate, isoamyl acetate, diethylene glycol monoethyl ether, diethylene glycol monoethyl ether acetate, benzyl alcohol, toluene, 3-methoxy-3-methylbutanol, triethylene glycol monomethyl ether, trienthylene glycol dimethyl ether, dipropylene glycol monomethyl ether, dipropylene glycol monobutyl ether, tripropylene glycol monomethyl ether, tripropylene glycol monobutyl ether, propylene carbonate, dimethylsulfoxide (DMSO), N-methyl-2-pyrrolidone, and so on. In particular, α-terpineol is preferable because of its high viscosity and good solubility of the resin binder or the like.

(Substrate with Sealing Material Layer)

A substrate with a sealing material layer being a second embodiment of the present invention has a sealing material layer made by firing the sealing material of the first embodiment of the present invention in a predetermined region on a surface of an inorganic material substrate. As the inorganic material substrate to be sealed, there can be cited a glass substrate, a ceramics substrate, a metal substrate, a semiconductor substrate, and so on, and the inorganic material substrate is not limited in particular. The inorganic material substrate is used properly according to a field and a purpose for which the inorganic material substrate is used. Further, the inorganic material substrate may be a flat plate, or may have a cavity. As the inorganic material substrate with a cavity, there can be cited, for example, low temperature co-fired ceramics (LTCC) with a cavity, and so on, fabricated by pressurizing and heating, and stacking a plurality of bored ceramics green sheets and sintering this stack.

Among the inorganic material substrates, the glass substrate and the ceramics substrate are preferable since sealing to the sealing material of the present invention with high sealing strength is possible. As the glass substrate, there can be cited a soda lime glass substrate, a borate glass substrate, a non-alkali glass substrate, a chemically strengthened glass substrate, a physically tempered glass substrate, and so on. The soda lime glass substrate and the non-alkali glass substrate are preferable as the glass substrate used for sealing of an electronic device. The soda lime glass substrate is preferable since a manufacturing cost can be reduced. On the other hand, the non-alkali glass substrate is suitable for use as a substrate of an electronic device since migration of an alkali component does not occur.

As the ceramics substrate, there can be cited a substrate made of an alumina sintered compact, a silicon nitride sintered compact, an aluminum nitride sintered compact, a silicon carbide sintered compact, an LTCC, or the like, and use of such a substrate is preferable.

Other than the above, for example, for use in illumination such as an LED, since high thermal conductivity is required, a metal substrate, a semiconductor substrate, or the like is preferable in addition to the LTCC. As the metal substrate, there can be cited a substrate made of an element metal such as aluminum, copper, iron, nickel, chromium, and zinc, or of an alloy of a combination containing at least one or more of the above. Further, a silicon substrate or the like can be cited as the semiconductor substrate.

(Sealing Method)

A method of laser sealing using the sealing material of the first embodiment of the present invention will be described by using the drawings. Note that the following method is an example of the sealing method and use of the sealing material of the present invention is not limited to the following method.

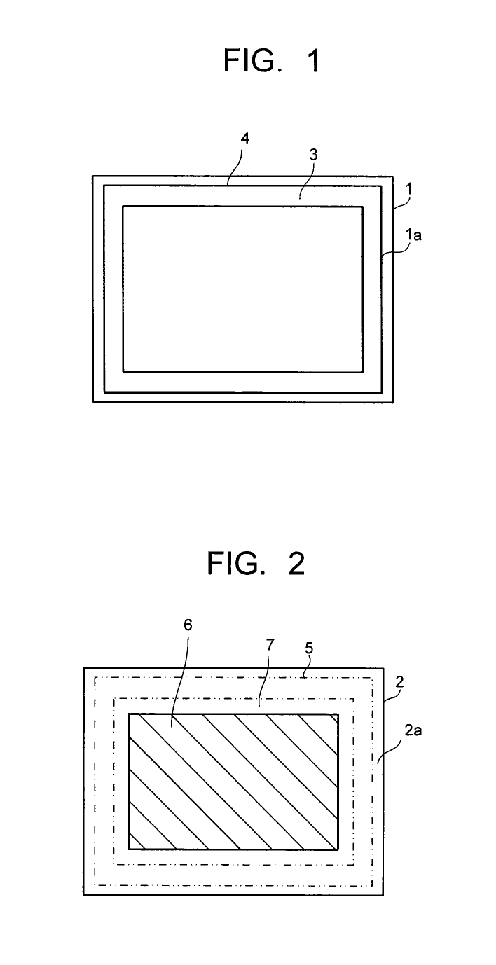

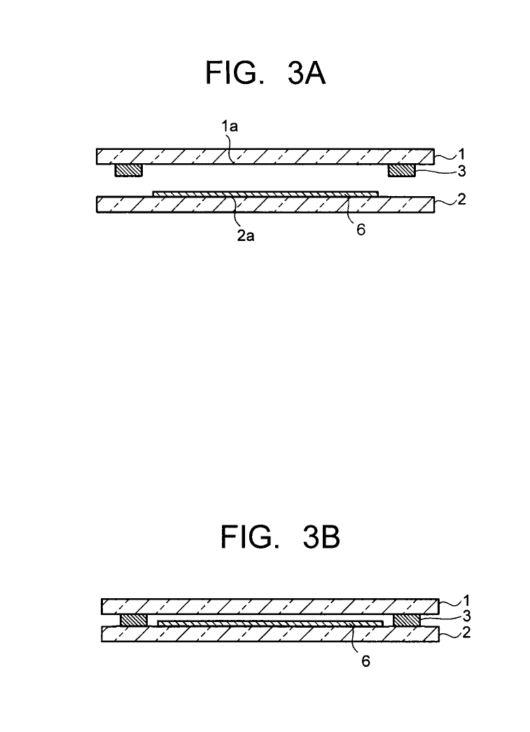

FIG. 1 is a plan view showing a first substrate 1 with a sealing material layer 3. The first substrate 1 is an inorganic material substrate having the sealing material layer 3 on a surface (hereinafter, referred also to as a “first surface”) 1a on a sealing side. Further, FIG. 2 is a plan view showing a second substrate 2. The second substrate 2 is an inorganic material substrate which does not have a sealing material layer on a surface (hereinafter, referred also to as a “second surface”) 2a on a sealed side (side to be sealed).

A forming method of the first substrate 1 of FIG. 1 will be described. First, an inorganic material substrate having a first sealing region 4 is prepared on the first surface 1a, and a coating layer is formed in the first sealing region 4 by applying the sealing material of the present invention in a frame shape. When the sealing material paste is used as the sealing material, the sealing material paste is dried after application, to form the coating layer.

The sealing material paste is applied along the sealing region 4 by a printing method such as screen printing and gravure printing, or by using a dispenser or the like, for example. The coating layer of the sealing material paste is preferable to be dried at a temperature of 120° C. or more for five minutes or more, though depending on an organic solvent to be used. A drying process is carried out in order to remove the organic solvent in the coating layer. If the organic solvent remains in the coating layer, there is a possibility that a resin binder component cannot be removed sufficiently in a firing process.

Next, the coating layer is fired, to form the sealing material layer 3 on the first surface 1a of the inorganic material substrate. The first substrate 1 with the sealing material layer 3 is obtained as described above. Firing layer is preferable to be carried out under a condition of heating at a temperature of 450° C. or more for 10 minutes or more, for example. Further, a condition that a crystal phase is not precipitated in the sealing material layer 3 is preferable.

The second substrate 2 of FIG. 2 will be described. The second substrate 2 has a second sealing region 5 on a second surface 2a of the inorganic material substrate. Note that when an electronic device is to be manufactured, an electronic element region 7 is provided more inside than the second sealing region 5 and the electronic element 6 is disposed in the region 7.

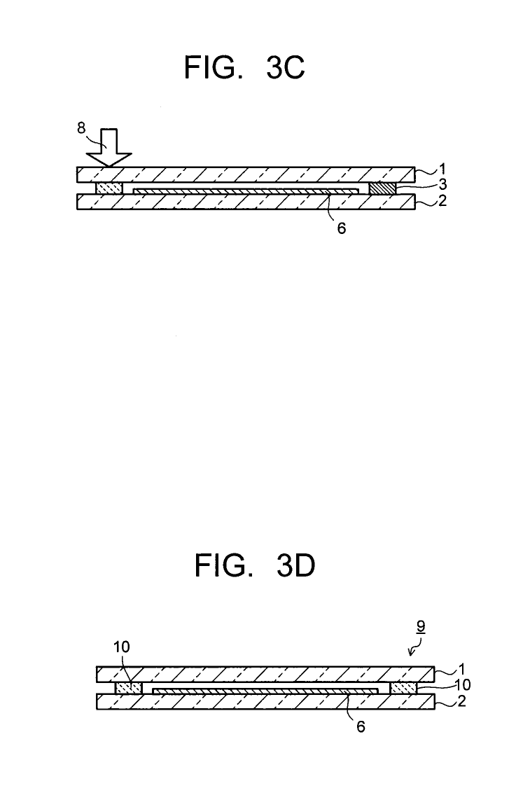

FIG. 3A to FIG. 3D are cross-sectional views showing processes of manufacturing a stack 9 by stacking the first substrate 1 and the second substrate 2 and irradiating laser light 8 from a not-shown laser light source to the sealing material layer 3. Note, since the stack 9 illustrated in FIG. 3D has the electronic element 6, the stack 9 is an electronic device of the present invention. According to an electronic device of the present invention, the electronic element region where the electronic element is disposed, is not limited on the second surface. For example, the electronic element region is provided on the first substrate as necessary. Further, according to the present invention, the stack may not have the electronic element which the stack 9 illustrated in FIG. 3D has. As example of the stack not having the electronic element, there can be cited double layer glass and the like.

FIG. 3A shows the process of making the first substrate and the second substrate 2 face each other. FIG. 3B shows the process of disposing and overlapping the first substrate 1 and second substrate 2 having been made to face each other. FIG. 3C shows the process of forming a sealing layer 10 between the first substrate 1 and the second substrate 2. FIG. 3D shows the process of obtaining the stack 9 in which the first substrate 1 and the second substrate 2 are sealed via the sealing layer 10 in a manner to seal the electronic element 6.

In order to manufacture the stack 9, first, as shown in FIG. 3A, the first substrate 1 and the second substrate 2 are made to face each other in a manner that the first surface 1a faces the second surface 2a. Then, as shown in FIG. 3B, the first substrate 1 and the second substrate 2 having been made to face each other are disposed and overlapped in a predetermined position with a predetermined space. Note that the space can be adjusted by using a not-shown spacer or the like.

Next, as shown in FIG. 3C, the sealing material of the sealing material layer 3 is melted, and next rapidly cooled and solidified, to form the sealing layer 10 between the first substrate 1 and the second substrate 2. Melting of the sealing material is carried out by irradiating laser light 8 for melting to the sealing material layer 3 from the not-shown laser light source disposed in an up direction (first substrate 1 side) of the stacked substrates. The laser light 8 for melting is not limited in particular, and desired laser light can be selected and used from semiconductor laser, carbon dioxide gas laser, excimer laser, YAG laser, HeNe laser, and so on.

Formation of the sealing layer 10 is carried out in a circumference of the sealing material layer 3. First, the laser light 8 is irradiated to an irradiation start position, and subsequently, the laser light 8 is made to scan along the sealing material layer 3. The laser light 8 is made to scan to an irradiation end position at least a part of which overlaps the irradiation start position of the laser 8, the sealing material layer 3 of all the circumference being heated and melted, and thereafter, irradiation of the laser light is terminated. Thereby, the sealing material layer 3 is melted and solidified to be the sealing layer 10, so that the sealing layer 10 is formed in the circumference of the sealing material layer 3. Then, as shown in FIG. 3D, the stack 9 in which the first substrate 1 and the second substrate 2 are sealed via the sealing layer 10 is obtained.

A heating temperature of the sealing material layer 3 is preferable, in relation to a softening temperature T (° C.) of glass powder, to be in a range of a temperature T₁ (=T+80° C.) or more to a temperature T₂ (=T+550° C.) or less. When heated to this temperature range, the glass powder in the sealing material is melted, so that the sealing material is sintered onto the second glass substrate 2 to form the sealing layer 10. Here, the softening temperature T of the glass powder indicates a temperature where the glass powder is softened and flowed but not crystalized. Further, a temperature of the sealing material layer 3 at a time that the laser light is irradiated is a value measure by a radiation thermometer.

Under an irradiation condition of the laser light 8 that the temperature of the sealing material layer 3 does not reach the temperature T₁, only a surface portion of the sealing material layer 3 is melted and the entire sealing material layer 3 cannot be melted uniformly, resulting in that glass does not flow, and there is a possibility that sufficient sealing cannot be done. On the other hand, under an irradiation condition of the laser light 8 that the temperature of the sealing material layer 3 exceeds the temperature T₂, a crack or the like becomes easy to occur in the first substrate 1, the second substrate 2, and the sealing layer 10.

A scanning speed of the laser light 8 is preferable to be 1 mm/sec to 20 mm/sec. When the scanning speed of the laser light 8 exceeds 20 mm/sec, a residual stress becomes large due to necessity of high laser output, so that a crack or the like becomes easy to occur in the substrate.

Output of the laser light 8 is preferable to be in a range of 10 W to 100 W. When the output of the laser light 8 is less than 10 W, there is a possibility that the sealing material layer 3 cannot be heated uniformly. On the other hand, when the output of the laser light 8 exceeds 100 W, the first substrate 1 and the second substrate 2 are heated excessively, leading to easy occurrence of a crack or the like.

A beam shape (that is, a shape of an irradiation spot) of the laser light 8 is not limited in particular. Though the beam shape of the laser light 8 is a circular shape in general, the shape is not limited to the circular shape but can be an elliptical shape whose minor axis is a width direction of the sealing material layer 3. With regard to the laser light 8 whose beam shape is formed into an elliptical shape, an irradiation area of the laser light 8 to the sealing material layer 3 can be enlarged and further the scanning speed of the laser light 8 can be increased. Thereby, a irradiation time of the sealing material layer 3 can be shortened.

In a irradiation process of the sealing material layer 3 by the laser light 8, a film thickness of the sealing material layer 3 is not necessarily limited. In laser sealing, as long as a film thickness of the sealing layer 10 after irradiation is 100 μm or less, the film thickness of the sealing layer 10 can be changed freely in correspondence with its purpose of use. On the other hand, when the thickness of the sealing material layer 3 exceeds 100 μm, there is a possibility that the entire layer cannot be heated uniformly by laser light. Note that the thickness of the sealing layer 10 is preferable to be 1 μm or more practically.

The sealing material of the first embodiment of the present invention is applicable to, in addition to sealing of inorganic material substrates used for a device for flat-type display apparatus or a lighting device, sealing of double layer glass for the purpose of a building material. As the device for the flat-type display apparatus, there can be cited an organic EL display (OLED), a plasma display panel (PDP), a liquid crystal display apparatus (LCD), and a field emission display. As the lighting device, there can be cited a light emitting element (light emitting diode, high intensity light diode, or the like), automobile lighting, decorative lighting, sign lighting, and advertising lighting. The sealing material of the first embodiment enables a white or transparent sealed portion, and thus is suitable in particular to a case where design of a sealed portion is required.

### EXAMPLES

Hereinafter, examples will be described. Note that the following description does not limit the present invention. Examples 1 to 3, examples 6 to 9, and an example 11 are examples, and examples 4, 5, 10 are comparative examples.

As a laser absorbent, ATO powder and ITO powder being transparent conductive oxide powder were prepared. D₅₀ of the ATO powder is 1.0 μm and D₅₀ of the ITO powder is 1.9 μm, and D₅₀ of ceramics powder is 4.3 μm. Further, as the laser absorbent, chemical compound powder (D₅₀: 1.2 μm) containing Fe, Mn, and Cu being black pigment was also prepared.

D₅₀ of the laser absorbent, the black pigment, and the ceramics powder were measured by using a particle analyzer (Microtrack HRA, manufactured by NIKKISO CO., LTD.). A measurement condition was that a measurement mode: HRA-FRA mode, Particle Transparency: Yes, Spherical Particles: No, Particle Refractive index: 1.75, Fluid Refractive index: 1.33. After a slurry in which each powder was dispersed in water and hexametaphosphoric acid was dispersed by an ultrasonic wave, D₅₀ was measured. D₅₀ of the glass powder was measured similarly.

### Example 1

As glass powder, there was prepared bismuth-based glass powder (softening temperature: 410° C.) having a composition of 83% of Bi₂O₃, 5% of B₂O₃, 11% of ZnO, 1% of Al₂O₃ in mass fraction, and as ceramics powder, cordierite powder (D₅₀: 4.3 μm) was prepared. A sealing material was prepared by mixing 60.7 vol % of glass powder of the above, 26.1 vol % of ceramics powder of the above, and 13.2 vol % of ATO powder. A linear expansion coefficient (50 to 350° C.) of the sealing material was 62×10⁻⁷/° C.

After 83 mass % of sealing material obtained as above and 17 mass % of vehicle were mixed and passed seven times through a triple-roll mill, the ceramics powder and ATO powder were dispersed sufficiently in a glass paste. Thereby, a sealing material paste 1 was prepared. As the vehicle, a mixture of 5 mass % of ethyl cellulose as an organic binder and 95 mass % of 2,2,4-trimethyl-1,3-pentanediolmonoisobutyrate as a solvent was used.

After the sealing material paste 1 was applied to a non-alkali glass substrate (linear expansion coefficient: 38×10⁻⁷/° C., dimension: 50 mm×50 mm×0.7 mm thickness) by a screen printing method, the sealing material paste 1 was dried and thereafter fired, to fabricate a first substrate 1 on a surface of which a sealing material layer was formed. For screen printing, a screen plate with a mesh size of 325 and an emulsion thickness of 20 μm was used. A pattern of the screen plate was a frame shape pattern of 30 mm×30 mm with a line width of 0.5 mm, a curvature radius R of a corner portion being 2 mm. After a coating layer of the sealing material paste was dried under a condition of 120° C. for 10 minutes, the coating layer of the sealing material paste was fired under a condition of 480° C. for 10 minutes, so that a sealing material layer with a film thickens of 15 μm and a line width of 0.5 mm was formed on the non-alkali glass substrate surface.

Next, the first substrate and a non-alkali glass substrate (second substrate) on a surface of which a sealing material layer was not formed were stacked, laser light was irradiated to the sealing material layer through the first substrate to melt the sealing material, and quick cooling solidification was carried out, whereby the substrates were sealed to each other.

With regard to the laser light, irradiation was carried out by a semiconductor laser under an irradiation condition of a spot radius of 1.6 mm and output of 30.0 W (power density: 1493 W/cm²) at a scanning speed of 4 mm/sec. An intensity distribution of the laser light was not formed to be constant, and laser light having a projecting intensity distribution was used. The spot radius at this time was obtained as follows. That is, the intensity distribution of the laser light was measured, and a radius in an almost circular region in which intensity of laser light was “1/e²” times or more of the maximum intensity was adopted as the spot radius.

### Examples 2 to 5

For each example, a sealing material paste was prepared under a condition similar to that in the example 1, except that kinds and compounding ratios of a sealing material were changed to a condition indicated in Table 1. A first substrate and a second substrate were sealed by using the sealing material paste of the above respectively. An example 4 is an example in which a laser absorbent is not used, and “-” is put in a column of a laser absorbent in the table.

(Evaluation)

In seal structures in the examples 1 to 5, presence/absence of a crack and pealing of a glass substrate and a sealed portion after laser sealing was observed by using an optical microscope. In Table 1, “No” is put when neither of the crack of the glass substrate and a sealed portion nor pealing of the sealed portion is recognized and “Yes” is put when either one is recognized.

Airtightness of the sealed portion in the examples 1 to 3 was evaluated by a helium leak test. Airtightness was measured by using ULVAC helium leak detector HELIOT. A test sample was fabricated under a condition similar to those in the above-described examples 1 to 3 except that a substrate having a hole of φ3 mm in a center of either one of glass substrates of the first substrate and the second substrate. With regard to examples 4, 5 an airtightness test was not carried out since a crack and pealing were found after sealing.

Exhaust of the inside of the test sample was carried out by connecting a vacuum pump to the hole until a background value reaches 1×10⁻¹¹ to 9×10⁻¹¹ Pa·m³/s. Next, a leakage rate of helium gas was measured by spraying helium gas to an outer peripheral portion of the test sample. As a result, in the examples 1 to 3, a degree of vacuum of about 1×10¹¹ to 9×10⁻¹¹ Pa·m³/s could be maintained even after spraying of helium gas, and no problem was recognized in airtightness.

The seal structures in the examples 1 to 3 were subjected to a temperature cycling test (1 cycle: 90 to −40° C., 500 cycles). Presence/absence of a crack and peeling of the glass substrate and sealed portion was observed before and after the temperature cycling test. Evaluation results thereof are shown together in Table 1. With regard to the examples 4, 5, since the crack and pealing were recognized after sealing, the temperature cycle test was not carried out.

TABLE 1

| | | Example 1 | Example 2 | Example 3 | Example 4 | Example 5 |
|---|---|---|---|---|---|---|
| Sealing | Glass powder | 60.7 | 66.8 | 60.7 | 69.9 | 25 |
| material | Ceramics powder | 26.1 | 28.8 | 26.2 | 30.1 | 0 |
| (vol %) | Laser absorbent | 13.2 | 4.4 | 13.1 | 0 | 75 |
| Sealing | Glass powder | 73.1 | 81.7 | 73.1 | 73.1 | 26 |
| material | Ceramics powder | 11.9 | 13.3 | 11.9 | 11.9 | 0 |
| (mass %) | Laser absorbent | 15 | 5 | 15 | 0 | 74 |
| Kind of laser absorbent | | ATO | ATO | ITO | — | ATO |
| (Transparent conductive oxide | | | | | | |
| powder) | | | | | | |
| Evaluation | Crack/pealing | No | No | No | Yes | Yes |
| result | after sealing | | | | | |
| | Airtightness | Yes | Yes | Yes | — | — |
| | Crack/pealing after | No | No | No | — | — |
| | temperature cycling | | | | | |

It is found from Table 1 that in the laser sealing using the sealing materials of examples 1 to 3 the crack/pealing is not present in the sealed portion and that the sealed portion with high airtightness can be formed.

On the other hand, in the example 4, the laser absorbent is not had. Thus, sealing cannot be carried out by laser heating and a crack occurs after sealing. In the example 5, a laser absorbent is contained but a content thereof is large, leading to reduction of fluidity of the glass powder, by which adhesiveness to the glass substrate is reduced, so that a crack occurs in the sealed portion.

### Example 6

A sealing material was prepared by using bismuth-based glass powder (softening temperature: 410° C., D₅₀: 1.2 μm) having a composition similar to that used in the example 1 as glass powder and by mixing 60.7 vol % of glass powder of the above, 26.1 vol % of ceramics powder, and 13.2 vol % of ATO powder. A linear expansion coefficient (50 to 350° C.) of this sealing material was 62×10⁻⁷/° C.

Note that the linear expansion coefficient of the sealing material was measured as described below. In other words, a sintered compact obtained by firing the sealing material in a temperature range of a softening temperature plus 30° C. to a crystallization temperature minus 30° C. of the glass powder for 10 minutes was polished, to fabricate a round bar of 20 mm in length and 5 mm in diameter. Then, a linear expansion coefficient of this sample was measured by TMA8310 manufactured by Rigaku Corporation. The linear expansion coefficient (50 to 350° C.) indicates a value of an average linear expansion coefficient in a temperature range of 50 to 350° C. measured as above. A sealing material paste 2 was prepared by using the sealing material obtained as above and by a composition and a method which were similar to those in the example 1.

The sealing material paste 2 was applied onto a substrate (dimension: 50 mm×50 mm×0.7 mm thickness) made of non-alkali glass (linear expansion coefficient (50 to 350° C.): 38×10⁻⁷/° C.) by a screen printing method. For screen printing, a screen plate with a mesh size of 200 and an emulsion thickness of 10 μm was used. A pattern of the screen plate and a curvature radius R of a corner portion were similar to those in the example 1. After screen printing, drying and firing were carried out similarly to in the example 1, to form a sealing material layer similar to that in the example 1. The non-alkali glass substrate on a surface of which the sealing material layer was formed, which was obtained as above, was a first substrate.

Next, after such a first substrate and a second substrate (dimension: 50 mm×50 mm×0.7 mm thickness) made of non-alkali glass on a surface of which a sealing material layer was not formed were stacked, laser light of 808 nm in wavelength was irradiated to the sealing material layer through the non-alkali glass substrate of the first substrate under a condition similar to that in the example 1. The laser light was irradiated at a scanning speed of 4 mm/sec while output was changed in a range of 20 W to 40 W to melt the sealing material, and quick cooling solidification was carried out. Then, an output range of the laser light in which the first substrate and the second substrate were sealable was investigated.

An intensity distribution and a spot radius of the laser light was similar to that in the example 1. Further, an output range of the laser light enabling sealing was a range in which adhesiveness of a sealed portion to the substrate was good and neither a crack of a glass substrate nor pealing of the sealed portion was recognized, after investigation of the sealed portion by using an optical microscope. An output margin M of laser was calculated from a width V₁ (=Vₘₐₓ−Vₘᵢₙ, Vₘₐₓ: upper limit value of output range, Vₘᵢₙ: lower limit value of output range) of the output range and a median value V₀ (=Vₘₐₓ+Vₘᵢₙ)/2 of the laser output, by using the following formula. It is for the purpose of comparing largeness of the output ranges of the laser light without regard to largeness of output values.

M=V₁/V₀

The output range enabling sealing and the output margin obtained as above are shown in Table 2.

### Example 7

The sealing material paste 2 was applied onto a substrate (dimension: 50 mm×50 mm×0.7 mm thickness) made of soda lime glass (linear expansion coefficient (50 to 350° C.): 83×10⁻⁷1° C.) by a screen printing method, to fabricate a first glass substrate similarly to in the example 6. Then, this first substrate and a second substrate made of soda lime glass on a surface of which a sealing material layer was not formed were stacked, laser light was irradiated to the sealing material layer through the soda lime glass substrate of the first substrate to melt the sealing material, followed by quick cooling solidification, whereby substrates were sealed to each other.

Then, an output range of laser light in which the first substrate and the second substrate were sealable was investigated similarly to in the example 6. Further, an output margin M of the laser was calculated.

The obtained output range enabling sealing and an output margin M are shown in Table 2.

### Example 8 to 10

With a compounding ratio of glass powder and ceramics powder as well as a kind and compounding ratio of a laser absorbent being set as shown in Table 2, a sealing materials having a linear expansion coefficient shown in Table 2 was prepared under a condition similar to that in the example 6, and thereafter, a sealing material paste was prepared for each example. Next, the obtained sealing material paste was applied onto a glass substrate shown in Table 2 by a screen printing method, to fabricate a first glass substrate similarly to in the example 6 respectively.

Next, the above first substrate and a glass substrate (second substrate), shown in Table 2, on a surface of which a sealing material layer was not formed were stacked, and laser light was irradiated to the sealing material layer through the first substrate to melt the sealing material, followed by quick cooling solidification, whereby the substrates were sealed to each other. Then, an output range of laser light in which the first substrate and the second substrates were sealable was investigated similarly to in the example 6. Further, an output margin M of laser was calculated.

The obtained output range enabling sealing and output margin M are shown in Table 2.

TABLE 2

| | | Example 6 | Example 7 | Example 8 | Example 9 | Example 10 |
|---|---|---|---|---|---|---|
| Sealing | Glass powder | 60.7 | 60.7 | 66.8 | 60.7 | 66.8 |
| material | Ceramics powder | 26.1 | 26.1 | 28.8 | 26.2 | 32.2 |
| (mass %) | Laser absorbent | 13.2 | 13.2 | 4.4 | 13.1 | 1 |
| Kind of laser absorbent | | ATO | ATO | ATO | ITO | Black |
| (Transparent conductive oxide | | | | | | pigment |
| powder) | | | | | | |
| Linear expansion coefficient | | 62 | 62 | 65 | 67 | 66 |
| (10⁻⁷/° C.) of sealing material | | | | | | |
| First and second glass | | Non-alkali | Soda lime | Non-alkali | Non-alkali | Soda lime |
| substrates | | glass | glass | glass | glass | glass |
| | | substrate | substrate | substrate | substrate | substrate |
| Laser | Output range | 25 to 40 | 20 to 30 | 40 to 70 | 25 to 29 | 15 to 17 |
| result | enabling sealing | | | | | |
| | (Vₘᵢₙ to Vₘₐₓ) (W) | | | | | |
| | Output median value | 33 | 25 | 55 | 27 | 16 |
| | V₀ (W) | | | | | |
| | Output margin M | 0.45 | 0.4 | 0.55 | 0.15 | 0.13 |

The following is found from Table 2. That is, in laser sealing using the sealing materials of the example 6 and the example 7 in which the glass powder, the ceramics powder, and the ATO powder are contained, with the ATO powder being contained in a range of 5 to 30 vol %, the output margins M are large, so that workability is good.

In the example 9, since the ITO powder is contained instead of the ATO powder as the laser absorbent, the output margin M of laser light enabling sealing with good adhesiveness where pealing, a crack or the like is not recognized is small. In the example 8, though the ATO powder as the laser absorbent is used, a content thereof is less than 5 vol %, and thus, similarly to in the example 6 and the example 7, the output margin M of the laser light in laser sealing is large but the output median value V₀ is also large. In other words, making output of the semiconductor laser be 40 W or more requires a plurality of laser light sources. Thus, there is a possibility that a running cost of the laser sealing is increased or a possibility that uniformity of a profile of a laser beam is reduced to lead to reduction of strength of sealing.

Further, in the example 10 in which the black pigment is used as the laser absorbent, not only because the output margin M of the laser light in laser sealing is small but also because the sealed portion is colored black, a sealed portion with good design cannot be obtained.

### Example 11

A sealing material paste 2 was applied onto a substrate made of non-alkali glass the same as that in the example 6 by a screen printing method, to fabricate a first glass substrate under a condition similar to that in the example 6. The first glass substrate and a second substrate made of LTCC with cavity as a second substrate other than glass were stacked. Then, it was confirmed that the substrates were sealable to each other as a result that laser light was irradiated to a sealing material layer through the first non-alkali glass substrate to melt a sealing material followed by quick cooling solidification.

A sealing material of the present invention, which can be used for sealing of an inorganic material substrate such as a glass substrate and coloring of a sealed portion is suppressed, is suitable for sealing of a portion from which design is required. Further, since it is possible to adopt a broad output range of laser light which enables sealing with high airtightness and without occurrence of pealing of a sealed portion or a crack of the glass substrate, stable sealing with a high working efficiency is possible.

What is claimed is:

1. A sealing material comprising:
30 to 99 mass % of a glass powder; and
1 to 70 mass % of a conductive metal oxide powder.

2. A sealing material comprising:
40 to 99 vol % of a glass powder; and
1 to 60 vol % of a conductive metal oxide powder.

3. The sealing material according to claim 1, further comprising:
a ceramics powder,
wherein a total content of the glass powder and the ceramics powder is more than 30 mass % and 99 mass % or less, and a content of the conductive metal oxide powder is 1 mass % or more and less than 70 mass %.

4. The sealing material according to claim 2, further comprising:
a ceramics powder,
wherein a total content of the glass powder and the ceramics powder is more than 40 vol % and 99 vol % or less, and a content of the conductive metal oxide powder is 1 vol % or more and less than 60 vol %.

5. The sealing material according to claim 1,
wherein the conductive metal oxide powder contains at least one selected from the group consisting of ITO powder, powder of tin-based oxide containing a dopant, and powder of ZnO containing a dopant.

6. The sealing material according to claim 1,
wherein the conductive metal oxide powder is powder of tin-based oxide containing a dopant.

7. The sealing material according to claim 5,
wherein the powder of tin-based oxide containing the dopant contains FTO powder and/or ATO powder.

8. The sealing material according to claim 5,
wherein D₅₀ of the powder of tin-based oxide containing the dopant is 0.1 μM to 5 μM.

9. The sealing material according to claim 5,
wherein a content of the powder of tin-based oxide containing the dopant is 5 to 30 vol %.

10. The sealing material according to claim 1,
wherein the sealing material is for laser sealing.

11. The sealing material according to claim 1,
wherein the glass powder is bismuth-based glass powder or tin phosphate-based glass powder.

12. The sealing material according to claim 3,
wherein the ceramics powder is one or more selected from the group consisting of magnesia, calcia, silica, alumina, zirconia, zircon, cordierite, zirconium phosphate tungstate, zirconium tungstate, zirconium phosphate, zirconium silicate, aluminum titanate, mullite, eucryptite, and spodumene.

13. A substrate with a sealing material layer, comprising:
an inorganic material substrate; and
a sealing material layer made by firing the sealing material according to claim 1, in a predetermined region on a surface of the inorganic material substrate.

14. The substrate with the sealing material layer according to claim 13,
wherein the inorganic material substrate is one selected from the group consisting of a glass substrate, a ceramics substrate, a metal substrate, and a semiconductor substrate.

15. The substrate with the sealing material layer according to claim 13,
wherein the inorganic material substrate is a soda lime glass substrate or a non-alkali glass substrate.

16. A stack comprising:
a first substrate having a first sealing region on a sealing side surface;
a second substrate having a second sealing region corresponding to the first sealing region on a surface facing the first substrate, the second substrate disposed over a predetermined space from the first substrate; and
a sealing layer disposed between the first sealing region and the second sealing region and made by melting and solidifying the sealing material according to claim 1.

17. An electronic device comprising:
a first substrate having a first sealing region on a sealing side surface;
a second substrate having a second sealing region corresponding to the first sealing region on a surface facing the first substrate, the second substrate disposed over a predetermined space from the first substrate;
an electronic element disposed between the first substrate and the second substrate; and
a sealing layer disposed between the first sealing region and the second sealing region in a manner to seal the electronic element and made by melting and solidifying the sealing material according to claim 1.

18. A substrate with a sealing material layer, comprising:
an inorganic material substrate; and
a sealing material layer made by firing the sealing material according to claim 2, in a predetermined region on a surface of the inorganic material substrate.

19. A stack comprising:
a first substrate having a first sealing region on a sealing side surface;
a second substrate having a second sealing region corresponding to the first sealing region on a surface facing the first substrate, the second substrate disposed over a predetermined space from the first substrate; and
a sealing layer disposed between the first sealing region and the second sealing region and made by melting and solidifying the sealing material according to claim 2.

20. An electronic device comprising:
a first substrate having a first sealing region on a sealing side surface;
a second substrate having a second sealing region corresponding to the first sealing region on a surface facing the first substrate, the second substrate disposed over a predetermined space from the first substrate;
an electronic element disposed between the first substrate and the second substrate; and
a sealing layer disposed between the first sealing region and the second sealing region in a manner to seal the electronic element and made by melting and solidifying the sealing material according to claim 2.
